(19) United States
(12) Patent Application Publication
(10) Pub. No.: US 2016/0086456 A1
(43) Pub. Date: Mar. 24, 2016

(54) Electronic Device With Electrically Controlled Button Indicator

(71) Applicant: Apple Inc., Cupertino, CA (US)

(72) Inventors: Michael B. Wittenberg, Sunnyvale, CA (US); Tommaso P. Rivellini, San Jose, CA (US)

(21) Appl. No.: 14/846,481

(22) Filed: Sep. 4, 2015

Related U.S. Application Data
(60) Provisional application No. 62/054,578, filed on Sep. 24, 2014.

(51) Int. Cl. G08B 5/36; H04M 1/02

(52) U.S. Cl. CPC G08B 5/36; H04M 1/0202; H04M 1/026

(57) ABSTRACT

An electronic device may have a housing. Electrical components may be mounted in an interior portion of the housing. A display may be mounted to the housing to display images for a user. A button may have a movable button member that moves inwardly and outwardly with respect to the housing. Control circuitry can use a sensor to monitor button press activity on the button. A visual indicator such as an electrophoretic display or other low power display may be mounted on a protruding portion of the button member. The control circuitry can alter the visual appearance of the visual indicator in response to detection of button presses on the button member. The button may be sealed to prevent intrusion of moisture into the interior of the housing.

This application claims the benefit of provisional patent application No. 62/054,578 filed on Sep. 24, 2014, which is incorporated by reference herein in its entirety.

### BACKGROUND

This relates generally to electronic devices, and, more particularly, to electronic devices with buttons.

Electronic devices such as cellular telephones, computers, and other electronic equipment often contain buttons. For example, a cellular telephone may have a ringer button that slides between a normal mode position and a silent mode position. Other types of devices have other types of buttons.

It is sometimes desirable to provide a user with visual feedback on the state of a button. For example, a sliding button may have text labels next to the button to provide a user with information on the state of the button. In some sliding buttons, a visual indicator such as a patch of colored paint may be placed on part of a button. When the button has been slid into a first position, the colored paint will be covered by part of a device housing and will not be visible to the user. When the button has been slid into a second potion, the colored paint will be uncovered and will be visible to the user.

Challenges may arise when using buttons such as these in an electronic device. In some designs, there is insufficient room available for text labeling or sliding buttons. Water resistance requirements and other constraints may also make it difficult or impossible to use traditional designs. At the same time, there is a desire to make visual information on the state of a button available to assist users.

It would therefore be desirable to be able to provide improved buttons for electronic devices.

### SUMMARY

An electronic device such as a portable electronic device may have a housing.

Electrical components may be mounted in an interior of the housing. A display may be mounted to the housing to display images for a user.

A button may be mounted in the housing. The button may have a movable button member that moves inwardly and outwardly with respect to the housing. The button member may be sealed to prevent intrusion of moisture into the interior of the housing. A biasing structure may be used to bias the button member outwardly.

A sensor may be coupled to the button member. Control circuitry can use the sensor to monitor button press activity for the button.

A visual indicator such as an electrophoretic display or other low power display may be mounted on a protruding portion of the button member. The control circuitry can alter the visual appearance of the visual indicator in response to detection of button presses on the button member.

### BRIEF DESCRIPTION OF THE DRAWINGS

FIG. 1 is a perspective view of an illustrative electronic device in accordance with an embodiment.

FIG. 2 is a schematic diagram of an illustrative electronic device in accordance with an embodiment.

FIG. 3 is a perspective view of an illustrative button in accordance with an embodiment.

FIG. 4 is a cross-sectional side view of an illustrative button showing how the button may be provided with a sealed shaft in accordance with an embodiment.

FIG. 5 is a cross-sectional side view of an illustrative button having sensing circuitry, optional haptic feedback, and a visual indicator to display button state information or other information in accordance with an embodiment.

FIG. 6 is a cross-sectional side view of an illustrative button to which electrical connection is being made using spring contacts in accordance with an embodiment.

FIG. 7 is a cross-sectional diagram showing how a button visual indicator may be formed from an electrophoretic display structure in accordance with an embodiment.

FIGS. 8 and 9 are cross-sectional diagrams showing how a microelectromechanical systems device that produces light interference may be used in producing visual output for a button in accordance with an embodiment.

FIG. 10 is a cross-sectional side view of an illustrative button visual indicator formed from an organic light-emitting diode structure in accordance with an embodiment.

FIG. 11 is a cross-sectional side view of an illustrative button visual indicator formed from a liquid crystal shutter in accordance with an embodiment.

FIG. 12 is a flow chart of illustrative steps involved in using a button with an electronically controlled visual indicator in accordance with an embodiment.

### DETAILED DESCRIPTION

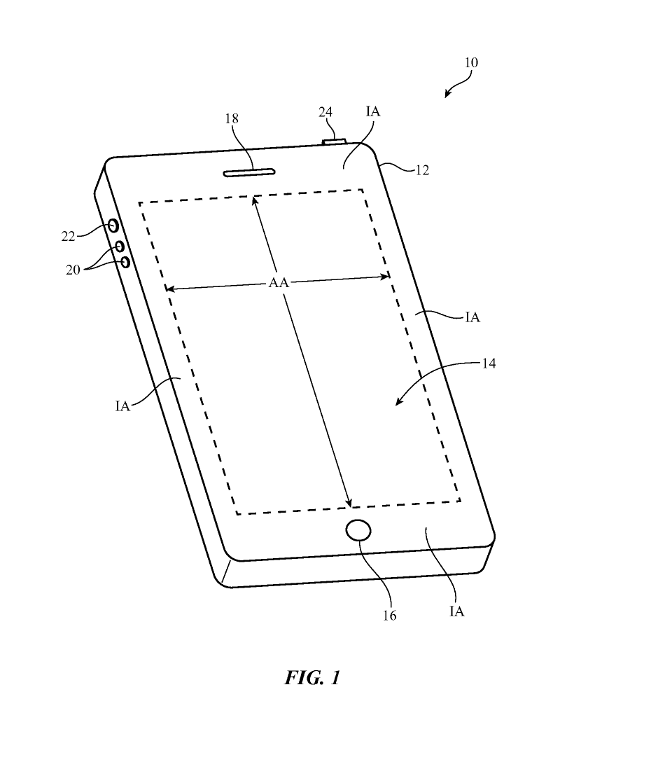

An electronic device such as electronic device 10 of FIG. 1 may contain buttons. To provide a user with visual information on the state of one or more of the buttons or other visual information, one or more of the buttons of device 10 may be provided with an electronically controlled visual indicator. One or more of the buttons in device 10 may also be provided with haptic feedback, if desired. The buttons may have moisture sealing to help prevent intrusion of moisture into an interior portion of the electronic device.

Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels or other light-emitting diodes, an array of electrowetting display pixels, or display pixels based on other display technologies. The array of display pixels may display images for a user in active area AA of display 14. Active area AA may be surrounded on one or more sides by inactive border regions such as inactive area IA.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18. Openings may be formed in housing 12 to form communications ports (e.g., an audio jack port, a digital data port, etc.), to form openings for buttons, etc.

In addition to buttons such as button 16 on the front face of device 10, device 10 may have buttons such as buttons 20, 22, and 24 (as examples). Buttons 20, 22, and 24 may be mounted to housing 12 (e.g., within openings in housing 12). Buttons 20 may be, for example, volume up and down buttons. Button 22 may be, for example, a ringer button that is used to place device 10 (e.g., a cellular telephone, etc.) into a silent mode in which ringer noises are suppressed or a normal mode in which the device can sound an audible alert in response to an incoming cellular telephone call or other activity. Button 24 may be used to awaken device 10 from a sleep state or to place a device that is awake into a sleep state and/or to power up and power off device 10. Other types of buttons may be used in device 10, if desired. Buttons 16, 20, 22, and 24 of FIG. 1 are merely illustrative.

It may be desirable to provide buttons in device 10 with visual indicators so that a user of device 10 can determine the state of the buttons from visual inspection. Configurations in which buttons such as button 22 of device 10 are provided with electronically controlled visual indicators that are used to indicate the current state of the buttons are sometimes described herein as an example. This is, however, merely illustrative. Any suitable structure in device 10 such as a portion of housing 12, portion of button 16, or portions of buttons such as button 20, 22, or 24 may be provided with a visual indicator and the visual indicator may be used to provide a user with any suitable type of information, if desired.

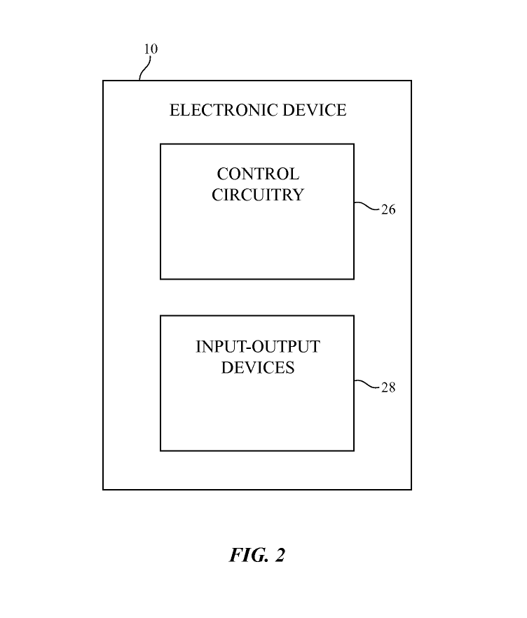

FIG. 2 is a schematic diagram of device 10. As shown in FIG. 2, electronic device 10 may have control circuitry 26. Control circuitry 26 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 26 may be used to control the operation of device 10. The processing circuitry may be based on one or more microprocessors, microcontrollers, digital signal processors, baseband processors and other wireless communications circuits, system-on-chip processors, power management units, audio chips, application specific integrated circuits, etc.

Input-output circuitry in device 10 such as input-output devices 28 may be used to allow data to be supplied to device 10 and to allow data to be provided from device 10 to external devices. Input-output devices 28 may include buttons, joysticks, scrolling wheels, touch pads, key pads, keyboards, microphones, speakers, tone generators, vibrators, cameras, sensors such as touch sensors, capacitive proximity sensors, light-based proximity sensors, ambient light sensors, compasses, gyroscopes, accelerometers, moisture sensors, light-emitting diodes and other visual status indicators, data ports, etc. A user can control the operation of device 10 by supplying commands through input-output devices 28 and may receive status information and other output from device 10 using the output resources of input-output devices 28.

Control circuitry 26 may be used to run software on device 10 such as operating system code and applications. During operation of device 10, the software running on control circuitry 26 may display images for a user on one or more displays and may use other internal components such as input-output devices 28. For example, the software running on control circuitry 26 may be used to process button input from a user using one or more sensors (e.g., capacitive touch sensors, mechanical sensors, thermal sensors, force sensors, switches, and other components) and may be used to maintain an electronically controlled visual button state indicator in an appropriate corresponding state. Control circuitry 26 may also be used in controlling the operation of haptic devices (e.g., solenoids, vibrators, or other components that provide physical feedback (e.g., vibrations) to a user in conjunction with a button press or other user activity). Haptic devices may be triggered when a button input is detected using a sensor or based on other criteria.

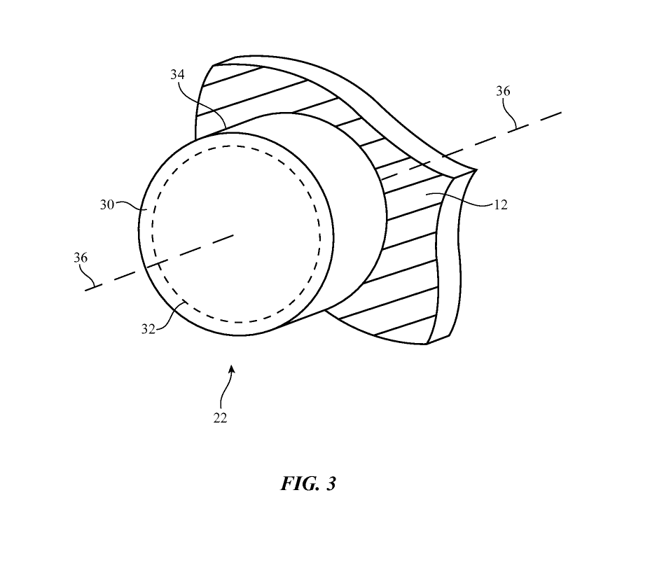

An illustrative arrangement of the type that may be used to provide a button with an electronically controllable visual indicator such as a button state indicator is shown in FIG. 3. In the perspective view of FIG. 3, a portion of housing 12 is shown that contains button 22. Button 22 has a protruding button member such as button member 34. Button member 34 may be a fixed structure that does not move with respect to housing 12 (e.g., an integral portion of housing 12 that protrudes from housing 12 or a separate structure that has been fixedly attached to housing 12) or may be a moving member such as a member that moves into and out of device housing 12 along longitudinal axis 36 (sometimes referred to as a button reciprocation axis or button movement axis). Configurations in which button member 34 moves relative to housing 12 are sometimes described herein as an example. This is, however, merely illustrative. Button 22 may be a fixed-position button that does not have a moving button member, if desired.

Some or all of button member 34 may be covered with an electrically controllable visual indicator such as visual indicator 32. In the example of FIG. 3, for example, button member 34 has circular face 30 and visual indicator 32 has a circular shape that is accommodated on face 30. Visual indicator 32 may exhibit multiple visual states. For example, visual indicator 32 may be placed in first and second different states or may exhibit three or more visually different visual states. Configurations in which visual indicator 32 is bistable and is placed into first and second distinct states are sometimes described herein as an example.

Control circuitry 26 of device 10 may electrically control the appearance of visual indicator 32. In general, control circuitry 26 may change the appearance of visual indicator 32 to provide any desired visual status indication or output to a user of device 10. With one suitable arrangement, which is sometimes described herein as an example, the visual output that device 10 provides with visual indicator 32 is related to the state of button 22 (as well as the state of device 10 that is associated with that button state). For example, visual indicator 32 may be provided with a first visual state when button 22 is in a first state (e.g., a state associated with operating device 10 in a silent mode or other mode) and may be provided with a second visual state when button 22 is in a second state (e.g., a state associated with operating device 10 in a normal (non-silent) mode.

The visual appearance of visual indicator 32 may toggle between any visually distinct states. For example, control circuitry 26 may direct visual indicator 32 to move between first and second distinct appearances such as black and white, red and white, red and black, a first color and a second color, a bright state and a dark state, a patterned state and a solid state, a first pattern such as a pattern with dots and a visually distinct second pattern such as a pattern with stripes, a pattern with moving content and a pattern with only stationary content, patterns with first and second distinct types of moving content, a pattern without blinking content and a blinking pattern, etc. Configurations for visual indicator 32 in which visual indicator 32 has only the ability to display a single “pixel” may result in simpler and less complex visual indicator structures. Arrangements in which visual indicator 32 has multiple independently controlled pixels may also be used, if desired.

The use of a visual indicator such as indicator 32 to display the current state of button 22 (or other device status information) may help reduce the size of button 22 and may enhance the ability of button 22 to be water-proofed. Indicator 32 may require relatively small amounts of lateral space along the exterior surface of housing 12. Sliding movement can be minimized or eliminated, which can facilitate the formation of moisture seals. Movement along longitudinal axis 36 may also be minimized by the elimination or reduction of purely mechanical button mechanisms, which may help enhance efficient use of space within device 10 and/or may minimize difficulties that might otherwise be encountered when forming seals to waterproof button 22 (e.g., by minimizing structures that exhibit sliding movement along the surface of housing 12, which can be challenging to seal).

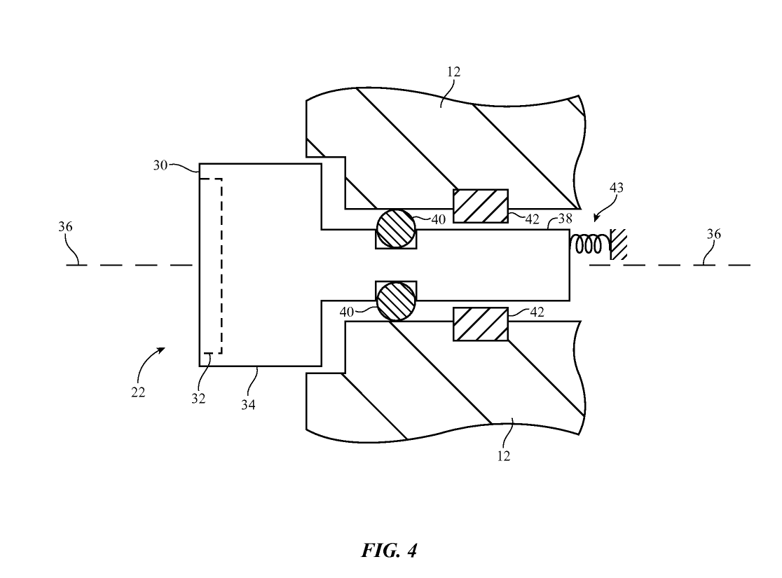

A cross-sectional side view of an illustrative configuration of the type that may be used in implementing button 22 of FIG. 3 is shown in FIG. 4. As shown in FIG. 4, button 22 may have a button member such as button member 34. Front surface 30 of button member 34 or other surface of button member 34 may be provided with visual indicator 32. Button 22 may move back and forth (inwardly and outwardly with respect to housing 12) along axis 36. A biasing structure such as spring 43 may be used to bias button 22 outwards (as an example). Mechanical mechanisms (e.g., heart-shaped cam mechanisms, etc.) may be used to provide button 22 with mechanical bistability (e.g., different first and second mechanically stable positions). Alternatively, button 22 may be a normally out button that can be momentarily pushed inwards to overcome the outward biasing force of spring 43 (i.e., button 22 may be a momentary button). Other types of button mechanism may be used, if desired (e.g., mechanically bistable mechanisms, momentary mechanisms, sliding mechanisms, rotary mechanisms, fixed structures, sliding buttons, etc.).

As shown in FIG. 4, button member 34 may have an elongated portion such as shaft 38 that extends along axis 36 and that is received within a housing structure such as portions of housing wall 12 or other button shaft support structure in device 10. To prevent moisture intrusion into the interior of device 10, shaft 38 may be provided with one or more shaft sealing structures such as O-ring 40. O-ring 40 may be formed from an elastomeric material that is compressed between the inner surface of the opening in housing 12 that receives shaft 38 and the outer surface of shaft 38.

Button member 34 may be formed from metal (e.g., stainless steel, etc.), plastic or other suitable materials. If desired, annular bearings such as bearing 42 may be used to help hold shaft 38 in alignment with axis 36. Bearings such as bearing 42 may be formed between housing 12 and the outer cylindrical surface of button member shaft 38. Bearing 42 may be formed from polytetrafluoroethylene or other slippery polymer, metal, or other materials (as examples). If desired, multiple O-ring seals, other sealing structures, multiple bearings 42, other bearing structures, button member retention features, and/or other button structures may be included in button 22. The shape of button member 34 may be circular (when viewed from the exterior of device 10), may be rectangular, or may have other suitable shapes. The example of FIG. 4 is merely illustrative.

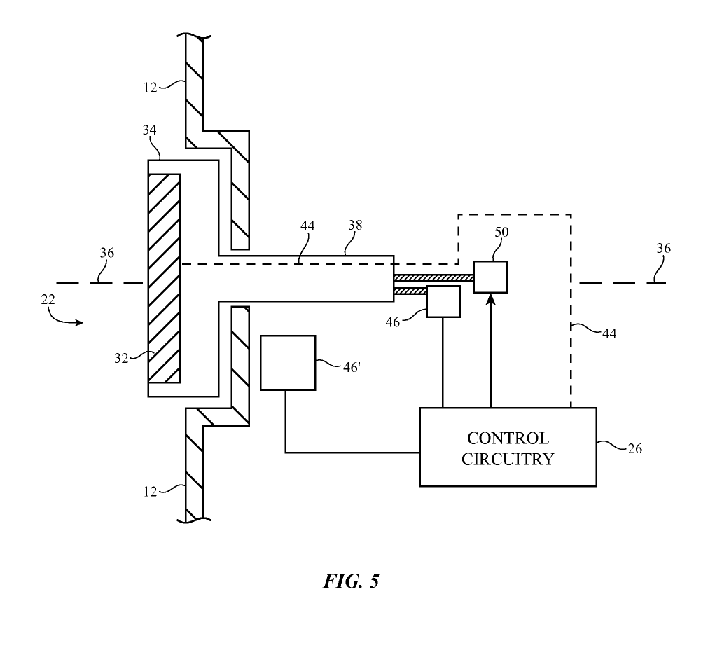

As shown in the example of FIG. 5, control circuitry 26 may be used in operating button 22. When a user presses on button member 34, button member 34 may travel inwardly into housing 12. When button member 34 is released, a biasing structure such as structure 43 of FIG. 4 or other structure may press button 34 outwardly along axis 36. Changes in the position of button member 34 along longitudinal axis 36 (i.e., the axial position of button 22) may be used to change the state of button 22 (in the example of FIG. 5).

The position of button 22 may be sensed using one or more sensors operated by control circuitry 26. Control circuitry 26 may, for example, use sensor 46 to detect whether button member 34 has been pressed inwardly along axis 36. Sensor 46 may be coupled to the end of shaft 38 or may be positioned elsewhere within device 10 to sense motion of button member 34.

Sensor 46 may be a force sensor that detects how forcefully button member 34 has been pressed inwardly, may be a switch that changes between its open and closed states when compressed by motion of button member 34, may be capacitive sensor that senses a change in capacitance between capacitor electrodes (e.g., a conductive portion of member 34 and an opposing sense electrode), may be a resistive sensor, may be an acoustic sensor, may be an optical sensor (e.g., a sensor with a light emitter and a corresponding light detector that can sense when shaft 38 or other portion of member 34 blocks or otherwise modifies the light emitted by the light emitter in the sensor), or may be any other suitable sensor. As shown by illustrative capacitive sensor 46′, it is not necessary to mount sensor 46 directly to shaft 38. Capacitive sensor 46′ may, as an example, sense changes in capacitance that result from movement of the head of button member 34 relative to sensor 46′ rather than directly sensing movement of shaft 38. Sensors such as sensor 46′ may sometimes be referred to as non-contact sensors because button member movement can be detected without contacting button member 34.

During operation of device 10, control circuitry 26 can continuously (or semi-continuously) monitor the state of button 22 using sensors such as sensor 46. When a user presses button 22, control circuitry 26 can detect the user button press and can take suitable action. For example, control circuitry 26 can alter the mode of operation of device 10 (e.g., by toggling between a “silent mode” and a “normal operating mode”, by making volume adjustments, by changing the playback of media by device 10, by toggling between sleep and awake states, by pausing or resuming media playback, or by making any other suitable alterations to the behavior of device 10).

In addition to altering the operation of device 10 in response to a detected button press from a user, control circuitry 26 can take actions that affect button 22. For example, in situations in which button 22 is fixed (i.e., button member 34 does not move along axis 36), in which travel of button 22 is limited, or other situations in which tactile feedback to a user is relatively weak, it may be desired to provide a user with haptic feedback using one or more electrically controlled actuators such as illustrative actuator 50. Actuator 50 may be, for example, a solenoid-driven haptic feedback actuator that can be activated by control circuitry 26 in response to detecting button press event using sensor 46. When activated in this way, actuator 50 may impart a thump or create other vibrations in button member 34 that serve as a type of mechanical feedback on the operation of button 22. When a user's finger or other body part is resting on or near button member 34, the vibrations from actuator 50 will be felt by the user and may even be mistaken for actual actuation of a spring-based mechanical button mechanism or other purely mechanical feedback mechanism. As a result, button presses will be accompanied by satisfying “clicks” from actuator 50 that help confirm to the user that button 22 has been satisfactorily pressed.

Regardless of whether tactile feedback is provided by mechanical mechanisms in button 22, is provided by electronically controlled actuator structures such as actuator 50, or is omitted (e.g., when using a fixed button without actuator 50), button press events and/or other status changes in device 10 may be accompanied by visual feedback in the form of changes in the visual appearance of visual indicator 32. As an example, consider a scenario in which device 10 is operating in a first mode. To indicate that button 22 has not been depressed and that device 10 is operating in the first operating mode, control circuitry 26 may direct visual indicator 32 to provide a first visual output (e.g., a first color, etc.). Control circuitry 26 can then monitor sensor 46 to determine when a user presses button 22. When a button press is detected by control circuitry 26, control circuitry 26 can direct visual indicator 32 to provide a second visual output that is distinct from the first visual output (e.g., a second color that is different than the first color, etc.). Control circuitry 26 can also take other suitable actions within device 10 in response to detection of the button press.

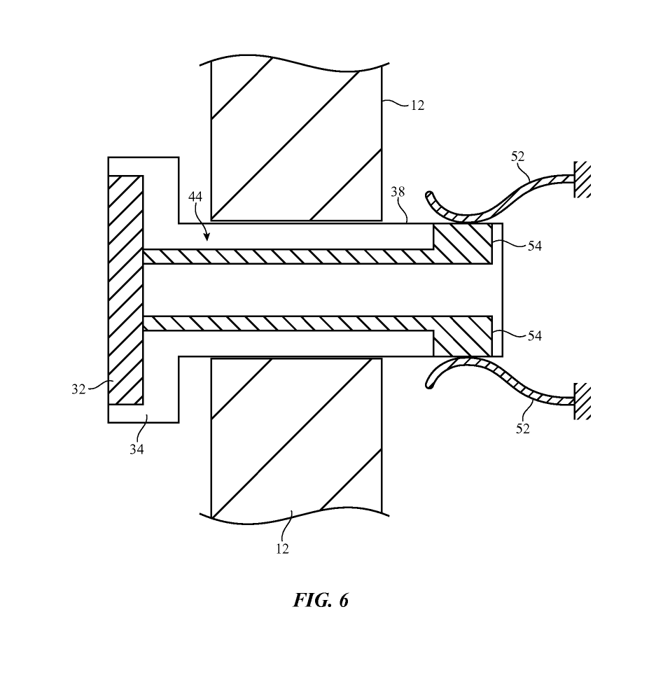

Control circuitry 26 can operate visual indicator 32 using a control path such as path 44. Path 44 may be implemented using wires within shaft 38 and/or adjacent to shaft 38, using traces on a flexible printed circuit or other printed circuit, using spring contacts (e.g., contact with a spring-loaded pin or a leaf spring), using traces on shaft 38, using other conductive signal path structures, or using combinations of these structures. In the example of FIG. 6, spring contacts 52 are being used to make contact with metal traces 54 on the outer surface of shaft 38. Metal traces 54 (in this example) are forming signal path 44 of FIG. 5. If desired, other suitable signal path structures may be formed in button 22. The configuration of FIG. 6 is illustrative.

Visual indicator 32 may be formed from any structures that can change visual appearance under electronic control of control signals from control circuitry 26. Configurations in which visual indicator 32 are formed from relatively low-power-consumption components may be helpful at extending battery life in device 10.

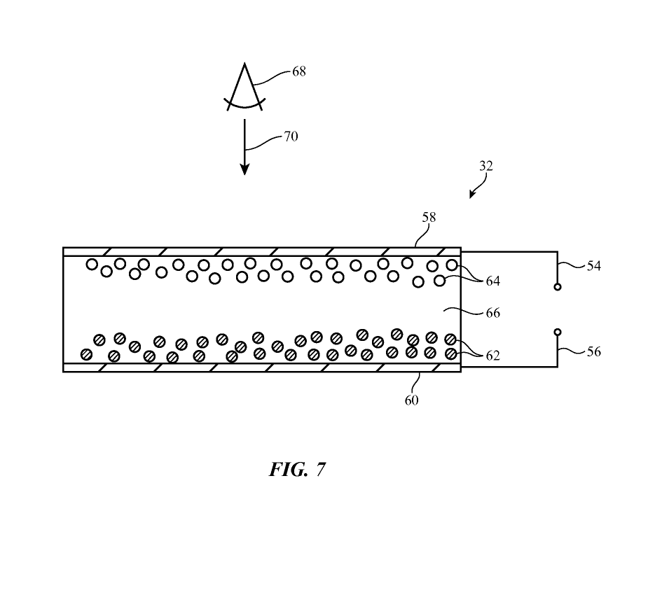

In the example of FIG. 7, visual indicator 32 is an electrophoretic visual indicator. A user such as viewer 68 may observe the status of visual indicator 32 in direction 70. Visual indicator 70 may have first and second electrodes such as upper electrode 58 and lower electrode 60. Upper (outer) electrode 58 may be formed from a transparent conductive material such as indium tin oxide on a transparent substrate, may be formed from a fine grid of thin metal lines on a transparent substrate, or may be formed from an optically thin conductive metal layer on a transparent substrate (as examples). Lower electrode 60 may be formed from metal (e.g., a metal coating on a substrate). Control circuitry 26 may control the amount of electric field imposed across fluid 66 by control the voltage applied across terminals 54 (coupled to electrode 58) and 56 (coupled to electrode 60). Particles (e.g., charged particles) may be suspended in fluid 66 and may change position due to electrostatic forces when control circuitry 26 controls the electric field across fluid layer 66. Charged particles 64 and 62 may have different colors or other distinguishable visual characteristics. For example, particles 64 may be white and particles 62 may be black.

When the electric field applied visual indicator 32 has a positive polarity, particles 64 will move to a position adjacent to upper transparent electrode 58 and particles 62 will move to a position adjacent to lower electrode 60. When particles 64 are adjacent to transparent electrode 58, viewer 68, who is observing indicator 32 in direction 70, will observe the color of particles 64 (i.e., visual indicator 32 will be white). When the polarity of the electric field is reversed, particles 64 will move to a position adjacent to lower electrode 60 and particles 62 will move to a position adjacent to upper electrode 58, so that visual indicator 32 will appear black. Visual indicator 32 can hold its state for days or weeks after the state of indicator 32 has been established by application of a suitable voltage across terminals 54 and 56, so visual indicator 32 may consume little or no power.

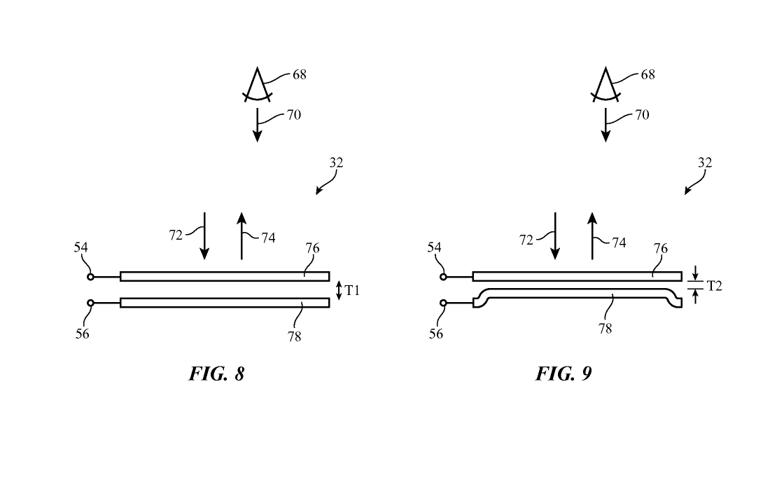

In the example of FIGS. 8 and 9, visual indicator 32 has been implemented using microelectromechanical systems (MEMs) structures that display visual changes through optical (light) interference. As shown in FIG. 8, visual indicator 32 has upper plate 76 (e.g., a partly transparent plate) and lower plate 78 (e.g., a reflective plate). The magnitude of the separation between plates 76 and 78 is adjusted using control voltages applied to terminals 54 and 56 using control circuitry 26. When a first voltage is applied across terminals 54 and 56, plates 76 and 78 will be separated by distance T1. Plates 76 and 78 form an etalon (of separation T1) that exhibits optical interference and imparts a first color to reflected light. For example, white light 72 that is incident on indicator 32 will be reflected as reflected light 74 and reflected light 74 will have a first color (e.g., red). When a second voltage is applied across terminals 54 and 56, the etalon will have a different separation T2, as shown in FIG. 9, so that reflected light 74 will have a different color (e.g., blue). Other MEMs structures may be used in forming visual indicator 32 if desired. The example of FIG. 9, which is based on a controllable optical etalon is merely illustrative.

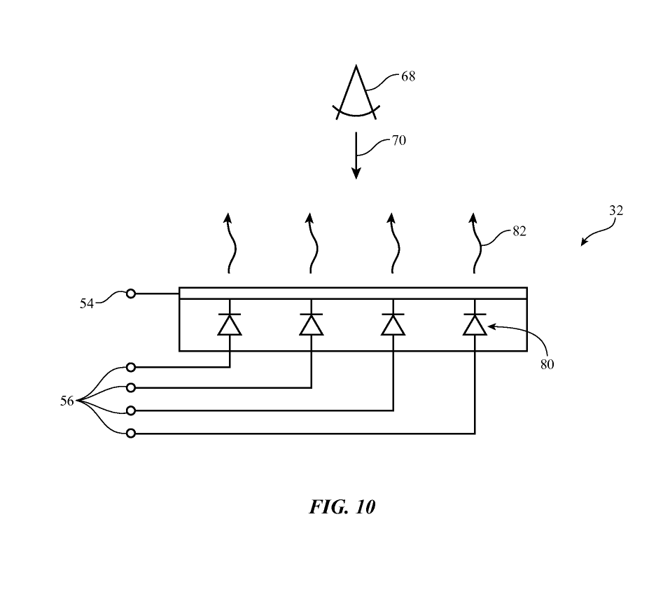

FIG. 10 shows how visual indicator 32 may be formed from light-emitting components such as light-emitting diodes 80. There may be one or more light-emitting diodes 80 in visual indicator 32. Light-emitting diodes 80 may be crystalline semiconductor diodes, may be organic light-emitting diodes, or may be other light-emitting structures. There may be one diode 80 in indicator 32, two or more diodes 80 in indicator 32, etc. Each diode 80 may have the same color or each diode 80 may have a different color. Configurations in which multiple diodes have the same color but in which indicator 32 contains more than one color of light-emitting diode may also be used. Diodes 80 may be controlled using signals applied to terminals 54 and 56. Diodes 80 may be controlled independently or may be controlled in parallel (e.g., so that multiple diodes are activated at once using shared cathode and/or shared anode structures). In the example of FIG. 10, indicator 32 has a shared cathode coupled to terminal 54 (e.g., a transparent cathode) and anodes that can be controlled independently or in unison. Light-emitting diode(s) 80 may emit light 82 of one or more different colors for user 68 to indicate the status of button 22 and/or device 10.

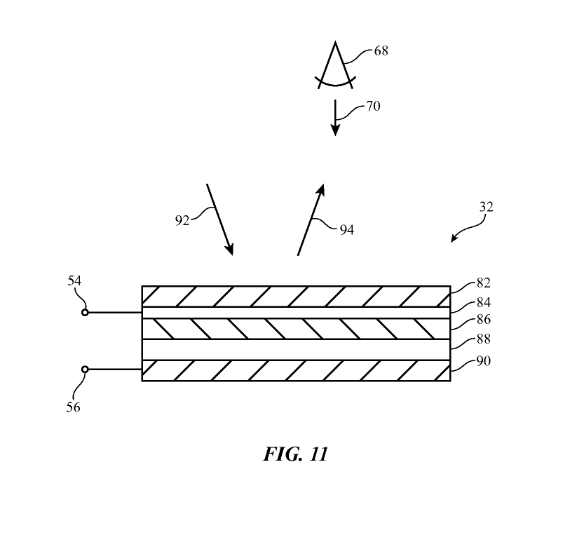

FIG. 11 shows how visual indicator 32 may be implemented using a liquid crystal display (LCD) shutter. Indicator 32 of FIG. 11 has an upper electrode such as electrode 84 and a lower electrode such as electrode 90. Electrode 90 may be formed from a reflective material such as metal and may be coupled to terminal 56. Upper electrode 84 may be a transparent electrode (e.g., a layer of indium tin oxide, etc.) that is formed on clear substrate 82 (e.g., glass, plastic, sapphire, crystalline material, amorphous material, etc.). Color filter material (e.g., dyed polymer, etc.) such as color filter layer 86 may be formed as a coating over electrode 84 on substrate 82. Liquid crystal layer 88 may be interposed between upper electrode 84 and lower electrode 90. Polarizer structures may be formed in indicator 32 (e.g., a pair of polarizers may be formed on opposing sides of layer 88). When a first electric field is applied across layer 88 by electrodes 84 and 90, incident light 92 will be reflected and reflected light 94 will acquire the color of color filter layer 86. When a second electric field is applied, reflected light 94 will be extinguished (i.e., indicator 32 will be black in this example). Other types of LCD shutter structure may be used (e.g., configurations with different color outputs, configurations that display different patterns in different states, etc.).

If desired, other visual indicator structures may be used in forming indicator 32 (e.g., structures based on plasma pixels, electrowetting displays, etc.). The configurations of FIGS. 8, 9, 10, and 11 are merely illustrative.

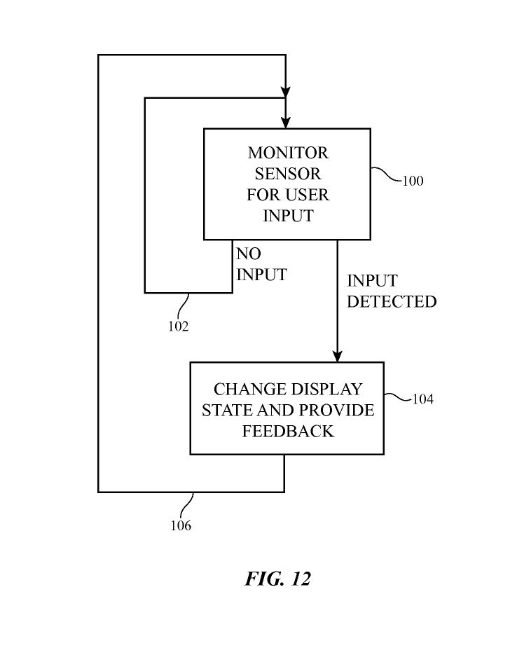

Illustrative steps involved in operating device 10 with buttons such as a button 22 having an electrically controlled visual indicator 32 are shown in FIG. 12.

At step 100, control circuitry 26 may monitor sensor 46 (and/or non-contact sensors such as sensor 46′) for changes indicating that a user has supplied button input to button 22. For example, control circuitry 26 may monitor sensor 46 to determine whether a user has pressed button member 34 inwardly. If no user button input is detected, processing can loop continuously back to step 100 for additional monitoring of button status, as indicated by line 102.

If, however, control circuitry 26 detects actuation of button 22 by a user, processing may continue at step 104. During the operations of step 104, control circuitry 26 may take appropriate action based on the detected pressing of button 22. For example, control circuitry 26 may change the visual output of visual indicator 32 (e.g., by toggling indicator 32 from a first color to a different second color, etc.). Control circuitry 26 may also direct actuator 50 to impart vibrations to button 22 to provide the user with haptic feedback (if desired). Control circuitry 26 may take suitable action within device 10 such as changing an operating mode from a first mode (e.g., a silent mode) to a second mode (e.g., a normal mode), may adjust settings related to media playback, may adjust settings related to cellular telephone operation, may adjust settings related to a camera, audio component, sensor, display, or other component in device 10, or may take other suitable action in response to detection of the button press. Processing may then loop back to step 100 for additional button input monitoring, as indicated by line 106.

Although visual indicator 32 has been described as being used by control circuitry 26 in the context of button 22, visual indicator 32 may be used in connection with button 16, buttons 20, button 24, or other buttons in device 10. Indicator 32 may also be incorporated into other portions of housing 12 and device 10 including portions that are not directly associated with buttons. For example, indicator 32 may occupy some or all of inactive area IA of display 14 to serve as a status indicator for device 10, may surround a data port or be formed adjacent to a data port, may be formed on a sidewall or rear housing wall in housing 12, may surround a button (i.e., indicator 32 may serve as a button trim), may surround a camera window (i.e., indicator 32 may serve as a camera trim), or may be placed on any other suitable visible portion of an electronic device for providing status information or other output to a user. The use of status indicator 32 on button 22 is merely illustrative.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a housing;
a button that protrudes from the housing;
control circuitry in the housing;
a sensor in the housing that the control circuitry monitors to detect a press of the button by a user; and
a visual indicator on the button that the control circuitry adjusts in response to detection of the button press.

2. The electronic device defined in claim 1 wherein the button moves relative to the housing in response to being pressed by the user.

3. The electronic device defined in claim 2 wherein the visual indicator is selected from the group consisting of: an electrophoretic visual indicator, a microelectromechanical systems visual indicator, and an organic light-emitting diode visual indicator, and a liquid crystal shutter visual indicator.

4. The electronic device defined in claim 3 wherein the sensor comprises a sensor selected from the group consisting of: a capacitive sensor, a force sensor, a light-based sensor, and a switch.

5. The electronic device defined in claim 4 wherein the button has an elongated button member with a shaft that moves in and out of the housing.

6. The electronic device defined in claim 5 further comprising a biasing structure that biases the shaft outward.

7. The electronic device defined in claim 1 wherein the electronic device has a display, wherein the button comprises a movable button member that moves inwardly and outwardly with respect to the housing, and wherein the visual indicator has a first state in which the visual indicator exhibits a first color and has a second state in which the visual indicator exhibits a second color.

8. The electronic device defined in claim 7 wherein the movable button member has a portion that protrudes out of the housing and wherein the visual indicator is located on the portion of the movable button member that protrudes out of the housing.

9. The electronic device defined in claim 8 wherein the visual indicator comprises an electrophoretic visual indicator.

10. The electronic device defined in claim 9 wherein the sensor comprises a force sensor.

11. The electronic device defined in claim 9 wherein the sensor comprises a capacitive sensor.

12. The electronic device defined in claim 9 wherein the sensor comprises a light-based sensor.

13. The electronic device defined in claim 9 wherein the button member has an elongated portion with signal lines for the visual indicator.

14. The electronic device defined in claim 9 wherein the control circuitry toggles the visual indicator between a first state indicative of operation of the electronic device in a normal mode in which incoming cellular telephone calls are accompanied by an audible alert and a second state indicative of operation of the electronic device in a silent mode in which the audible alert is suppressed.

15. The electronic device defined in claim 1 wherein the button comprises a movable button member that moves inwardly and outwardly with respect to the housing, the electronic device further comprising an actuator that the control circuitry uses to impart haptic feedback to the button member in response to detection of the button press.

16. A cellular telephone, comprising:
a display;
a housing in which the display is mounted;
a button having a movable button member that moves inwardly and outwardly with respect to the housing;
a sensor;
control circuitry that detects a button press on the button using the sensor; and
a visual indicator on the button member that the control circuitry adjusts in response to detection of the button press.

17. The cellular telephone defined in claim 16 wherein visual indicator comprises a visual indicator selected from the group consisting of: an electrophoretic visual indicator, a microelectromechanical systems visual indicator that adjusts an etalon, and an organic light-emitting diode display.

18. The cellular telephone defined in claim 17 wherein the control circuitry toggles the visual indicator between a first state indicative of operation of the cellular telephone in a normal mode in which incoming cellular telephone calls are accompanied by an audible alert and a second state indicative of operation of the cellular telephone in a silent mode in which the audible alert is suppressed and wherein the button is sealed to prevent intrusion of moisture into the housing.

19. An electronic device, comprising:
a display;
a housing in which the display is mounted, wherein the housing has an interior;
a button having a movable button member that moves inwardly and outwardly with respect to the housing;
a sensor;
control circuitry that detects a button press on the button using the sensor; and
a visual indicator on the button member that the control circuitry adjusts in response to detection of the button press, wherein the visual indicator comprises a visual indicator selected from the group consisting of: an electrophoretic visual indicator, a microelectromechanical systems visual indicator that adjusts an etalon, and an organic light-emitting diode display.

20. The electronic device defined in claim 19 further comprising:
a seal that prevents intrusion of moisture into the interior of the housing.

21. The electronic device defined in claim 20 wherein the visual indicator comprises an electrophoretic visual indicator.

22. The electronic device defined in claim 21 wherein the sensor is a non-contact sensor that does not directly contact the movable button member.
